(19) United States
(12) Patent Application Publication
(10) Pub. No.: US 2025/0037597 A1
(43) Pub. Date: Jan. 30, 2025

(54) AUTONOMOUS FRAMEWORK FOR LEARNING AND TEACHING PROCESSES

(71) Applicant: Innocent LeGrand Watat, Bradford (CA)

(72) Inventor: Innocent LeGrand Watat, Bradford (CA)

(21) Appl. No.: 18/533,988

(22) Filed: Dec. 8, 2023

Related U.S. Application Data
(60) Provisional application No. 63/516,095, filed on Jul. 27, 2023.

(51) Int. Cl. G09B 5/08; G06Q 50/20

(52) U.S. Cl. CPC G09B 5/08; G06Q 50/205

(57) ABSTRACT

An information technology system for an autonomous teaching and learning automation framework is disclosed. The framework is used for autonomous teaching and learning process by leveraging and mining a wide variety of historical data and real-time data to deliver a dynamic, automated, autonomous, customized, personalized and user-centric learning curve in a way that boost engagement, learning and knowledge retention while generating more historical and statistical data thru various important reports. The framework includes an engine for identifying new autonomous processes, wherein the processes are generated for asynchronous teaching and learning. Real-time feedback is used along with validations for each task. An orchestration module is used for orchestration tasks along with validations and execution of the tasks to ensure learning of each learner/participant. In some embodiments, the framework is used for autonomously deploying software such as an operating system by asynchronously developing the processes for different types of deployment executors.

### CROSS-REFERENCE TO RELATED APPLICATION

The present application claims priority to, and the benefit of, U.S. Provisional Application No. 63/516,095, which was filed on Jul. 27, 2023, and is incorporated herein by reference in its entirety.

### FIELD OF THE INVENTION

The current innovation is situated within the realm of autonomous systems, delving specifically into a novel groundbreaking engineering Process Automation Framework (cPAF or PAF) to be known as watatomation. This framework seeks to revolutionize education through the comprehensive automation of an autonomous teaching and learning system, ushering in what we term as the “watatization” of education. The system seamlessly enhances and facilitates the learning mechanism as well as the teaching mechanism through automation using a set of concepts. Any teaching or learning mechanism of a subject may be autonomous with personalized experiences using the concepts through the defined information technology (IT) engineering methodologies and techniques. Information technology engineering is the engineering discipline that deals with the generation, distribution, analysis, and use of information, data, and knowledge in systems. The components of information technology engineering include more theoretical fields such as machine learning, artificial intelligence (AI), control theory, signal processing, and information theory, and more applied fields such as computer vision, natural language processing, bioinformatics, medical image computing, cheminformatics, autonomous robotics, mobile robotics, and telecommunications. Many of these originate from computer science, as well as other branches of engineering such as computer engineering, electrical engineering, and bioengineering. The field of information technology engineering is based heavily on mathematics, particularly probability, statistics, calculus, linear algebra, optimization, differential equations, variational calculus, and complex analysis. The autonomous teaching and learning mechanism will be adaptable and may be completed in various settings including classrooms, online sessions, and synchronous or asynchronous manners. Accordingly, the present disclosure makes specific reference thereto. The invention aims to establish a seamlessly automated system capable of executing predefined tasks autonomously, eliminating the need for human intervention. Its autonomous functionalities, complemented by a personalized touch, enable adaptive actions during learning, execution, deployment, and more. This adaptability extends itself dynamically to the variation of the environments, fostering evolution in sync with the surrounding context. The automated, autonomous teaching and learning system is transitioning from a futuristic vision to an imminent reality. This advancement not only would furnish substantial information and data useful for various formidable reports or real-time analysis but also would enhance artificial intelligence systems, paving the way for more effective and personalized learning experiences for both learners and educators alike. Nonetheless, it is to be appreciated that aspects of the present invention are also equally applicable to other like applications, devices, embedded systems, and methods of manufacture.

### BACKGROUND

By way of background, individuals learn ideas and concepts at different paces. Some individuals learn quickly, while others learn more slowly. The natural variability in learning speed makes it difficult to control the pace of teaching and learning for every individual in real-time. Teaching in an asynchronous way, not requiring learners to be online at the same time, is challenging without knowing the capabilities and progress of each learner. Without data, it's hard to ensure that asynchronous learning is efficient, making the effectiveness of asynchronous learning to be hindered by the absence of pertinent data. In current teaching systems, historical data on the learning process of a learner is not accessible in real-time, statistical data on the teaching outcome on a subject is not accessible in real-time and as a result, it is impossible to control in real-time the evolution of the teaching process. Without historical and statistical data, it is also impossible to control or dynamically influence in real-time the evolution of learning process of every single learner and to follow and determine his specific learning path and speed.

Though electronic devices or textbooks are sometimes used, current teaching and learning systems are mainly manual and require a teacher to teach a group of students or learners. Finding a multidisciplinary and multifunction proficient teacher that can deliver with the same expertise in multiple subjects/lessons and with the same dexterity is not only difficult but is also expensive with hefty price tag. The prevalent approach involves furnishing teachers and learners with books (physical or electronic) for interactive learning. In current systems, automation of the teaching and learning processes is lacking and there is no objective way of identifying if the intended knowledge being transmitted to a learner was mastered or effectively absorbed. While attempts were made to introduce automation in teaching and learning concepts, these efforts proved ineffective, and particularly did not adapt to asynchronous teaching and learning methods. Some automation attempts are hoping to use AI as a tool; instead, this innovation, beyond its purpose, would provide AI with significant amounts of real-world data from millions of actual case scenarios. Unlike traditional survey, population sample methods used for extrapolation or data gathered without certification, the collected data in this case would be certified and directly sourced from live systems, making it highly valuable for real-time usage and studying learners from various perspectives.

Currently, tests, assessments or evaluations take place only after the conclusion of a chapter or lesson to assess the learners, to check their level of understanding on the subject or lesson. In some colleges it could only be possible at the end of a week, month, quarter, trimester, or semester. The delay in gauging the learners' comprehension levels hinders the timely identification of incomplete understanding on specific topics or lessons and does not allow to dynamically influence in real-time of the evolution of his learning process. Also, in the prior art, it is not uncommon that occasionally the grades of some learners may be inflated by those responsible of the evaluation system for various reasons in a way that the real level of the learner ends up compromised. Individuals desire an improved and personalized autonomous teaching and learning system and method that can overcome the problems associated in the systems of the prior art.

Therefore, there exists a long felt need in the art for an improved teaching and learning system that is autonomous and uses historical and statistical granular level data to among others positively and dynamically influence in real-time of the evolution of his learning process. Additionally, there is a long felt need in the art for an autonomous system that uses an automation framework to organize into pieces such as a teaching or learning method into granular elements/components. Moreover, there is a long felt need in the art for a system that offers a distinct set of principles, techniques, methodologies as part of the new process of automation framework and concepts. Further, there is a long felt need in the art for a specially designed autonomous education system that facilitates asynchronous learning in any type of environment. The need extends to a system utilizing a work breakdown structure up to the lowest grainy level to automate learning, with the named system applicable to various other settings, including the deployment and execution of software processes in diverse devices. Also, there is a long felt need in the art for an autonomous system that helps improve education to address the toughest challenges facing communities around the world. There is a long felt need in the art to keep indefinitely the learner's granular historical data (learning curve, learning speed, test results, evaluation results, etc.) to always be able to review the gaps in that specific situations in a way to retrieve the historical records for meta-analysis, for generated reports or for real-time control dynamically of his learning evolution. Finally, there is a long felt need in the art for an improved engineering process-based learning and teaching system that can be autonomous using IT engineering methodologies and techniques.

The subject matter disclosed and claimed herein, in one embodiment thereof, comprises IT engineering methodologies and techniques based automation system for automating processes such as teaching and learning processes, software execution and software deployment processes. The system comprising a new automation opportunity module configured to identify new automation processes. A corresponding task definitions module including reusable components and associated tasks. A version control module for managing different versions of existing processes. An analyze module for assessing the state of current processes and generating automation recommendations. A design module for creating automations based on recommendations. A continuous assessment module for evaluating designed automations. A development module for developing new automations using reusable components. An integrate module for incorporating new automations into existing processes. An orchestration build console for coordinating and storing autonomous processes. An autonomous engine with a relational database for storing orchestration and historical data. A reporting engine for generating reports on processes. An operation administrator module for system operation and administration. A delivery team for activating new processes. A monitoring team for monitoring processes and providing feedback. A reporting team for generating real-time reports on the processes and an access management and security module for controlling access to system components. The reporting team can also generate a trace tracking the customized learning journey on a subject because that data would be saved indefinitely and retrievable at any time to understand the learning journey of a learner and variable specifics to that subject at the time of the autonomous learning. These queries would permit to group the queried data into different personas for data analysis, public policies recommendations and anticipate the likelihood path that a learner may follow given his personas.

Through this approach, the automation system introduced in the present invention not only achieves the afore-mentioned objectives but also furnishes users with a groundbreaking process autonomous framework conceptualization, specifically tailored for automating diverse processes, including teaching, learning, software execution as in embedded systems, and software deployment is millions of devices. Drawing inspiration from the work breakdown structure commonly employed in engineering, the system adeptly dissects elements and components into manageable grainy pieces. This versatile system extends its applicability across a multitude of purposes, offering a dynamic solution that provides real-time feedback. By harnessing the power of historical and statistical data, the system ensures not only efficiency but also an adaptive and dynamic environment, marking a significant advancement in the realm of process automation.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises an automation system used for generating autonomous teaching and learning processes, deployment of processes, software management processes and more. The system is based rooted on work breakdown structure that uses a modular structure and divides the process into a plurality of components or elements. Employing tasks orchestration, the system ensures continuous improvement and disaster prevention while maintaining the integrity of each orchestration task; it adeptly collects and saves indefinitely execution data and possesses code development capabilities which facilitate repetitive actions. The collected data can be used to create personalized processes or to dynamically influence in real-time the autonomous course of processes.

The subject matter disclosed and claimed herein, in another embodiment thereof, comprises a teaching and learning automation system for automating teaching and learning processes. The system comprising a new automation opportunity module configured to identify new teaching and learning processes. A corresponding task definitions module including reusable components and associated learning tasks. A version control module for managing different versions of teaching and learning processes. An analyze module for assessing the state of teaching and learning processes and generating automation recommendations. A design module for creating automations based on recommendations. A continuous assessment module for evaluating designed automations. A development module for developing new automations using reusable components. An integrate module for incorporating new automations into existing teaching and learning processes. An orchestration build console for coordinating and storing autonomous learning processes. An autonomous engine with a relational database for storing orchestration and historical data. A reporting engine for generating reports on teaching and learning processes. A virtual campus providing personalized autonomous learning experiences to learners. An operation administrator module for system operation and administration. A course delivery team for activating courses and learning processes. A course monitoring team for monitoring teaching and learning processes and providing feedback. A course reporting team for generating real-time reports on teaching and learning processes and an access management and security module for controlling access to system components.

In a further embodiment of the present invention, a method for automating teaching and learning processes using a teaching and learning automation system is described. The method comprising the steps of identifying new teaching and learning processes using a new automation opportunity module, defining reusable components and corresponding learning tasks within a corresponding task definitions module, managing multiple versions of teaching and learning processes with a version control module, analyzing the state of teaching and learning processes and generating automation recommendations using an analyze module, designing new automations based on the recommendations with a design module, continuously assessing designed automations using a continuous assessment module, developing new automations using reusable components and technology stored in the corresponding task definitions module and additional technology components, integrating the newly developed automations into existing teaching and learning processes with an integrate module, and coordinating and storing autonomous learning processes using an orchestration build console.

The method for automating teaching and learning processes further comprising the steps of storing orchestration and historical data within an autonomous engine and its relational database, generating reports on teaching and learning processes using a reporting engine, providing personalized autonomous learning experiences to learners through a virtual campus, activating courses and learning processes, either manually or automatically, through a course delivery team, monitoring teaching and learning processes and providing feedback through a course monitoring team, generating real-time reports on teaching and learning processes using a course reporting team, and controlling access to system components using an access management and security module.

In yet a further embodiment, a method and system for orchestrating tasks is described. The method provides a comprehensive and adaptive approach to delivering orchestrated tasks (reusable components). The method encompasses a series of pre-validation, execution, and post-execution validation steps for each orchestrated task, ensuring that an actor such as a learner or deployment executor receives accurately delivered information. For each specific orchestrated task, rigorous pre-execution and pre-registration validations are conducted to assess the readiness of the actor. During the execution of the task, the system can also identify and suggest dynamically autonomous new learning methods or new learning options when appropriate. Following the execution, a post-execution validation is performed to evaluate whether the actor has mastered the task.

In another aspect, a method and system for orchestrating virtual campus learning experiences is described. The method provides a comprehensive and adaptive approach to delivering orchestrated tasks (reusable components) to learners. The method encompasses a series of pre-validation, execution, and post-execution validation steps for each orchestrated task, ensuring that learners on the virtual campus receive accurately delivered content. For each specific orchestrated task, rigorous pre-execution and pre-registration validations are conducted to assess the readiness of the learner. During the execution of the task, the system can also identify and suggest autonomous new learning methods when appropriate. Following the execution, a post-execution validation is performed to evaluate whether the learner has mastered the task.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a diagrammatic view of the teaching and learning automation system of the present invention in accordance with the disclosed architecture;

FIG. 2 illustrates a flow chart depicting use of orchestrated tasks in the automatic teaching and learning system of the present invention in accordance with the disclosed architecture;

FIG. 3 illustrates a flow chart depicting a process of using the reporting engine for customizing the learning and teaching processes in accordance with the disclosed architecture;

FIG. 4 illustrates a diagrammatic view showing automation of deployment services or a technology using the automation system of the present invention in accordance with the disclosed architecture; and

FIG. 5 illustrates a line diagram showing orchestration process for deployment for the automation system in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for an improved teaching and learning system that is autonomous and uses historical and statistical data. Additionally, there is a long felt need in the art for an autonomous system that uses an automation framework to organize into pieces such as a teaching or learning method into granular elements/components. Moreover, there is a long felt need in the art for a system that offers a distinct set of principles, techniques, methodologies as part of the new process of automation framework and concepts. Further, there is a long felt need in the art for a specially designed autonomous education system that facilitates asynchronous and personalized learning in any type of environment. Furthermore, there is a long felt need in the art for a system that uses work breakdown structure to automate learning and can be used in different environments such as deployment of software processes, software management processes, or embedded systems in electronic devices. Also, there is a long felt need in the art for an autonomous system that helps improve education to address the toughest challenges facing communities around the world. Finally, there is a long felt need in the art for an improved engineering process-based learning and teaching system that can be autonomous using IT engineering methodologies and techniques.

The present invention, in one exemplary embodiment, is a teaching and learning automation system for automating teaching and learning processes. The system has modular structure and includes a new automation opportunity module configured to identify new teaching and learning processes. A corresponding task definitions module including reusable components and associated learning tasks. A version control module for managing different versions of teaching and learning processes. An analyze module for assessing the state of teaching and learning processes and generating automation recommendations. A design module for creating automations based on recommendations. A continuous assessment module for evaluating designed automations. A development module for developing new automations using reusable components. An integrate module for incorporating new automations into existing teaching and learning processes. An orchestration build console for coordinating and storing autonomous learning processes. An autonomous engine with a relational database for storing orchestration and historical data. A reporting engine for generating reports on teaching and learning processes. A virtual campus providing personalized autonomous learning experiences to learners. An operation administrator module for system operation and administration. A course delivery team for activating courses and learning processes. A course monitoring team for monitoring teaching and learning processes and providing feedback. A course reporting team for generating real-time reports on teaching and learning processes and an access management and security module for controlling access to system components.

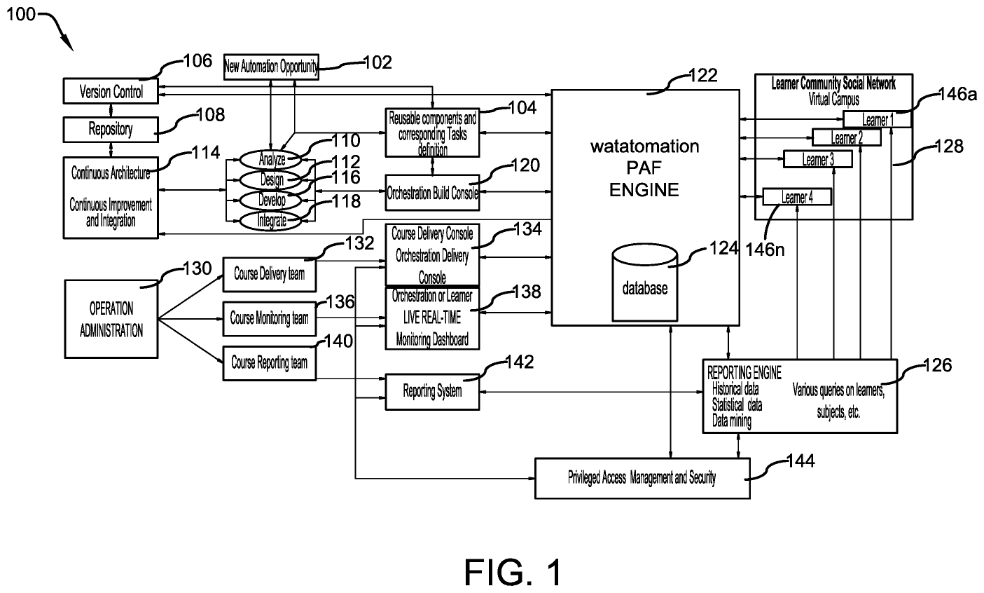

Referring initially to the drawings, FIG. 1 illustrates a diagrammatic view of the teaching and learning automation system of the present invention in accordance with the disclosed architecture. The teaching and learning automation system 100 of the present invention is designed to automate teaching and learning processes. The system 100 is configured to facilitate automation of both the teaching and learning mechanisms. Further, the system 100 can be adapted for different settings, including classrooms, online sessions, and both synchronous and asynchronous modes. The system 100 is preferably computer implemented and may involve computer programming, software development, and data management techniques. The system 100 keeps real-time track of the progress and involves orchestration of the tasks.

A new automation opportunity module 102 is configured to automate identification of the new teaching and learning process. The new automation opportunity module 102 uses reusable components and corresponding task definitions module 104. The module 104 includes reusable components such as lessons, chapters, subjects, and more, and corresponding tasks associated with learning. A version control module 106 maintains different versions of different teaching and learning processes. The different versions enable for easy tracking and rollback of changes. All the versions are stored in a repository 108 which can be in the form of a database. The repository 108 can be a relational or non-relational database and further can be maintained remotely and centrally, or in a distributed configuration.

The analyze module 110 analyzes the state of the teaching and learning process, identifies areas for improvement, and generates recommendations for automation. The new automation opportunities identified in the module 102 using the module 104 are also based on the results of the analyze module 110. The design module 112 designs new automations based on the recommendations from the analyze component 110. The design module 112 is also coupled with the continuous assessment module 114, wherein the designs developed by the design module 112 are continuously assessed by the assessment module 114. Based on the assessment, the development module 116 develops the new automations using the reusable components and technology stored in the reusable components and corresponding technology component 104. It will be apparent to a person skilled in the art that the new components may also be used by the development module 116 while developing the new automations. The integrate module 118 is configured to integrate the new automations into the existing teaching and learning process for improving and personalizing the learning processes for a plurality of learners. An orchestration build console 120 is coupled with the modules 110, 112, 116, 118 and orchestrates the processes correctly and consistently. The orchestration is necessary so that autonomous learning processes are correctly built and stored in the system 100.

An autonomous engine 122 is the core of the system 100 and includes a relational database 124. The autonomous engine 122 stores orchestration built by the console 120 and the reusable tasks are stored in the autonomous engine 122. The database 124 stores historical data, statistical data, metadata and more of learners and courses received from a reporting engine 126. The database 124 also stores secure access information of different users for accessing the system 100. The reporting engine 126 is also configured to generate reports on the teaching and learning process using the data from the historical data, statistical data, and metadata of learners and different learning processes.

The autonomous engine 122 is also configured to provide a virtual campus 128 which is in the form of a learner community social network and includes a plurality of virtual learners 146a-n. In one embodiment, the learners can interact and collaborate with each other. The learners receive personalized and real-time autonomous learning processes from the autonomous engine 122. The virtual learners can be in the form of personalized applications for users. Further, the virtual learners are coupled with the reporting engine 126 for receiving queries from learners on different subjects and more.

An operation administrator module 130 is configured to monitor the overall operation and administration of the system 100. The module 130 is preferably automatically operated and has operations to control all operational elements of the system 100. More specifically, the module 130 can be operated using one or more operators. A course delivery team 132 manually or automatically delivers and activates a course or learning process. The course delivery team 132 activates the courses using a course delivery console 134 which uses the autonomous engine 122 for automatic delivery of the courses and learning processes for virtual learners.

A course monitoring team 136 is responsible for monitoring the teaching and learning process and providing feedback to the autonomous engine 122. A real-time monitoring dashboard 138 is provided to the course monitoring team 136 to update information about the processes which is updated in real time in the database 124. A course reporting team 140 uses the reporting system 142 for providing real-time reporting on the teaching and learning process. The report may include access information, historical information, metadata of courses, queries of learners and more which are stored in the reporting engine 126.

An access management and security module 144 is adapted to provide access information for different teams 132, 136, 140. When a user of the team tries to access one of the consoles, the module 144 coordinates with the database 124 to access security information and accordingly provides access to the teams.

The automatic teaching and learning processes system 100 automates teaching and learning processes and can be adapted for various settings, including classrooms, online sessions, and both synchronous and asynchronous modes. The orchestration helps in automatic development of software or educational processes and elevates the quality and standards in software development. In a preferred embodiment, the system 100 uses work breakdown structure (WBS) which breaks down educational content into lessons, chapters, subjects, and actions for better control and management. The autonomous engine 122 collects data about the execution of each task and module, for continuous improvement.

The system 100 is modular and analyzes needs of virtual learners to create adaptable and customized learning and teaching processes automatically. The new automations are prepared using reusable components and the new automations are integrated into the teaching and learning processes. The system 100 can be used for different types of technologies, education, genre and more and makes evolution of education simple while enabling monitoring of the teaching and learning processes.

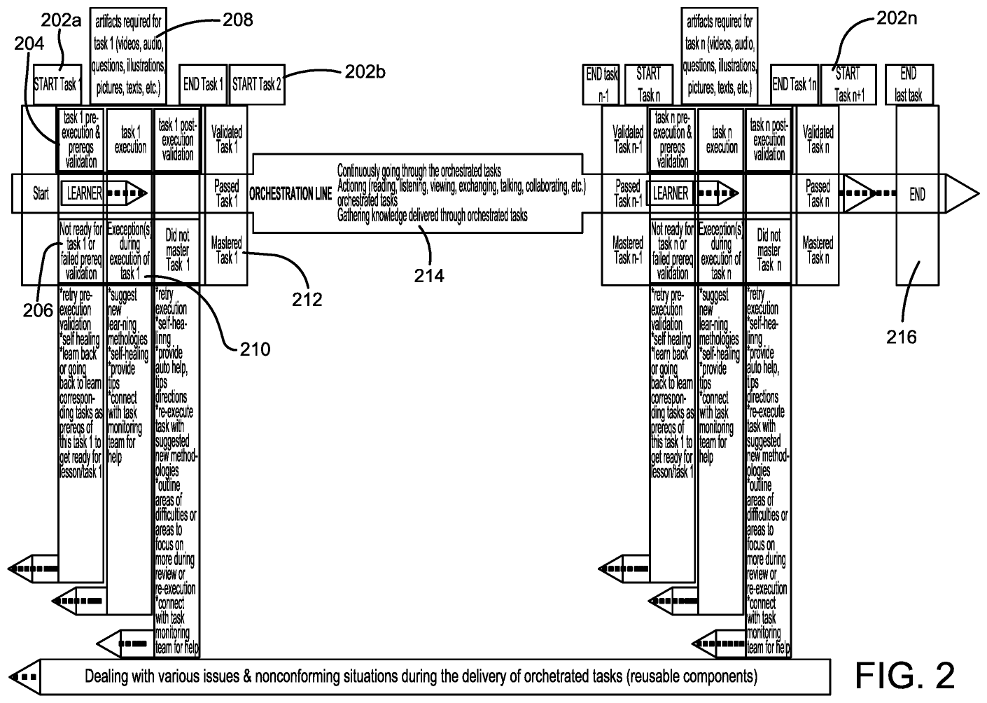

FIG. 2 illustrates a flow chart depicting use of orchestrated tasks in the automatic teaching and learning system of the present invention in accordance with the disclosed architecture. As illustrated, orchestrated tasks (reusable components) are delivered along with artifacts for the teaching and learning processes. For each orchestrated task 202a-n, pre-validation, execution, and post-execution validation are performed such that for each learner of the virtual campus 128 orchestrated tasks are accurately delivered. For each task, such as “orchestrated task 1” 202a, post activation of the “task 1” 202a, pre-execution and pre-registration validations are performed (Block 204) and it is determined if the learner is not ready for the “orchestrated task 1” 202a (Block 206). In case the learner is ready, then the task 202a is executed (Block 208) and artifacts such as videos, audios, questions, illustrations, pictures and more required for the task 202a are provided (Block 208). During execution of the task 202a, exceptions such as an autonomous new learning method is identified and suggested for the learner (Block 210). After execution of the task 202a, post-execution validation (Block 212) of the task 202a is performed. The post-execution validation determines whether the learner for which the orchestration is performed, mastered task 202a. In case it is determined that the learner did not master the task, then, re-execution of the task 202a is suggested along with helps, tips, directions, and more. After continuous and real-time review as described above, the validation and mastery of the task 202a is determined and it is determined if the learner has passed the task 202a or not.

Similar to the “orchestrated task 1” 202a, the learner goes through the subsequent orchestrated tasks along an orchestrated line 214. For each orchestrated task, pre-validation, execution, and post-validation are performed before enabling the learner to pass the orchestrated task and moving to the subsequent orchestrated task. When all the orchestrated tasks are passed till the last task 202n, the orchestration process is finished indicated by END 216.

The orchestration line 214 is like a supply chain and helps in planning and scheduling the delivery of the tasks, monitoring the progress of the tasks, managing dependencies between the tasks, and communicating with different stakeholders such as course delivery team, course monitoring team, reporting team and more.

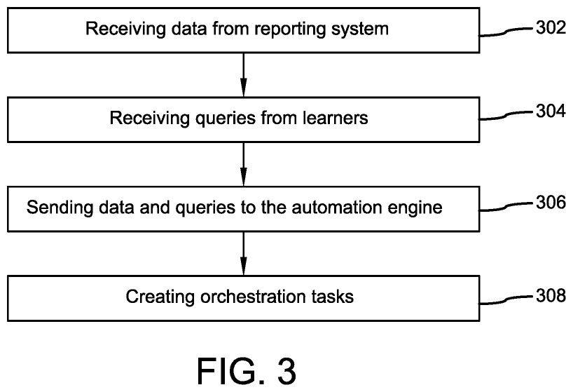

FIG. 3 illustrates a flow chart depicting a process of using the reporting engine for customizing the learning and teaching processes in accordance with the disclosed architecture. Initially, the reporting engine 126 receives historical data about courses and learners, statistical data, and metadata from the reporting system 142 (Step 302). The reporting engine 126 simultaneously receives queries from learners on subjects and more (Step 304). Then, the received information is sent to the autonomous engine 122 for storage in the database 124 (Step 306). Finally, the information is used by the autonomous engine 122 for creating orchestration tasks, new autonomous learning, and teaching processes and more (Step 308).

Historical data can be earlier teaching and learning processes, access information of learners and more and helps in providing a customized and personalized automation learning plan for the learner. Statistical data can be any number of learners accessing a learning program, data on number of learners mastered orchestrated tasks, the number of mastered tasks, and more. Statistical data may help in identifying and using reusable tasks and in maintaining the orchestrated pipeline. Statistical methods and/or Data analytics could be applied to these data points to initially determine the likely path of a new learner, perhaps to help generate “big learning wins” early in the process to increase learner engagement, boost their confidence and keep them “hooked up” for continuous learning.

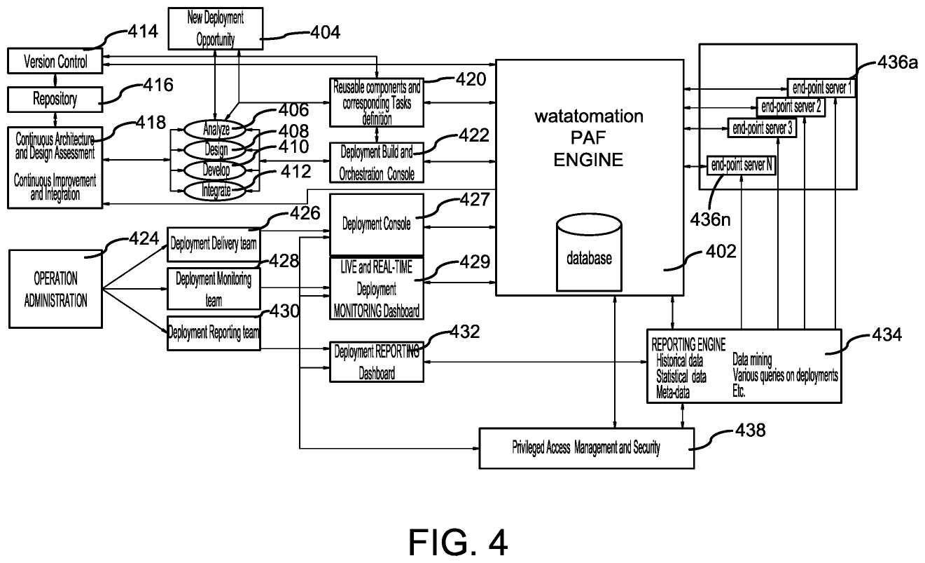

FIG. 4 illustrates a diagrammatic view showing automation of deployment services or a technology using the automation system of the present invention in accordance with the disclosed architecture. The autonomous process deployment system 400 can be used for automatically deploying a new application, software, and the like, such as an operating system. The system 100 can also be used for deploying new applications and processes in vehicles, trains, airplanes, embedded systems in electronic materials, and more. The architecture of the system 400 is similar to the architecture of the system 100 and includes a central autonomous engine 402. The autonomous engine 402 helps in deployment and orchestration of deployment process tasks.

A new deployment opportunity module 404 identifies new opportunities based on analysis of existing deployments and requirements by the analyze module 406. The new deployments are designed, developed, and integrated using the design module 408, develop module 410 and integrate module 412 respectively. Different versions of the deployments are maintained by the version control module 414 and are stored in a repository 416. The integrated new deployments are continuously checked and assessed for improvement by the continuous design assessment module 418. For analysis and new deployment opportunities, reusable components, and corresponding tasks module 420 is used and deployment build is deployed using orchestration console 422.

For operations of the deployment the deployments, an operation administrator 424 monitors the overall deployment operations. A deployment delivery team 426 is responsible for deploying the deployment using the deployment console 427, a deployment monitoring team 428 monitors the state of the deployment using a monitoring dashboard 429 and a reporting team 430 reports the use, state, and other characteristics of the deployment using the reporting dashboard 432. A reporting engine 434 receives the reporting information from the reporting dashboard 432 and uses the reporting information such as the historical data, statistical data, metadata and more for helping the autonomous engine 402 to select reusable components to build orchestration line.

The reporting engine 434 also receives and provides different queries on deployments and more from a plurality of end-point servers 436a-n which are used for autonomous deployments of processes. For authorized access of the system 400 by different teams and users, an access management module 438 is provided which stores the access information of all teams to prevent unauthorized access.

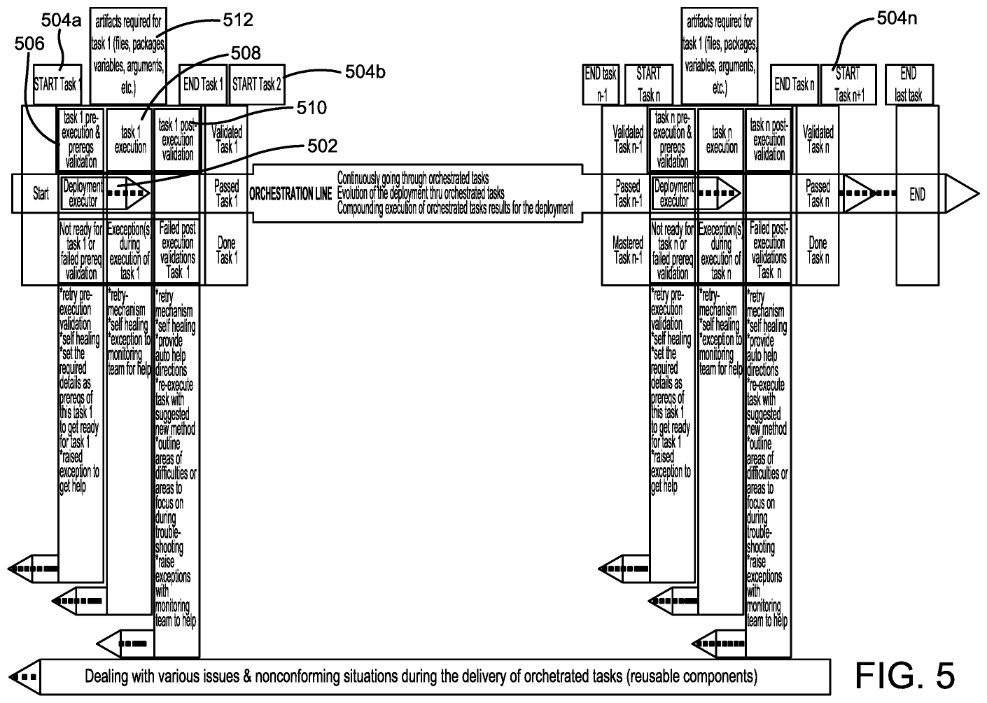

FIG. 5 illustrates a line diagram showing orchestration process for deployment for the automation system 400 in accordance with the disclosed architecture. A deployment executor 502 which can be one of the end-point server of FIG. 4 is provided with a plurality of reusable tasks 504a-n. Initially, a first task 504a is executed and before execution, pre-execution validation is performed using module 506. After task execution 508, post-execution validation 510 is performed. Similar to other embodiments, in pre-execution validation, it is determined if the deployment executor 502 is not determined for executing the task 504a. Exceptions are generated during the execution and recommendations, help, and re-execution is suggested during the post-execution validation. The orchestration process is complete when all the reusable tasks are successfully completed by the deployment executor 502.

For deploying a process, software and the like through the orchestration process, artifacts 512 such as files, packages, variables, arguments are more are provided for reusable task. It will be apparent to a person skilled in the art that artifacts for each of the reusable task can be same or different and the deployment executor can master one or more tasks in an autonomous manner. Further, the tasks are customized for the deployment executor based on the validations done before and after execution and hence, enables deployment in asynchronous manner.

The systems 100, 400 can generate code during development of process and deployment to avoid doing repetitive actions usually filled with various human errors. The code generation is an automatic action which can be performed by autonomous engine or develop module and is done to streamline the development process and to minimize errors or mishaps during the development and therefore to ensure the reliability and stability of the operations/execution's outcomes.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “teaching and learning automation system”, “autonomous process deployment system”, “automation system”, and “system” are interchangeable and refer to the information technology engineering process automation framework 100, 400 of the present invention.

Notwithstanding the forgoing, the information technology engineering process automation framework 100, 400 of the present invention can be of any suitable configuration as is known in the art without affecting the overall concept of the invention, provided that it accomplishes the above stated objectives. One of ordinary skill in the art will appreciate that the information technology engineering process automation framework 100, 400 as shown in the FIGS. is for illustrative purposes only, and that many configurations of the information technology engineering process automation framework 100, 400 are well within the scope of the present disclosure.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A teaching and learning automation system comprising:
an autonomous teaching and learning system having an automation opportunity module is configured to automate identification of teaching and learning processes, a task definitions module, a version control module for maintaining different versions of different said teaching and learning processes, a repository including a relational database, an analyze module, and a design module;
wherein said repository is maintained remotely and centrally;
wherein said analyze module analyzes the state of said teaching and learning processes, identifies areas for improvement, and generates recommendations for automation;
wherein said automation opportunity module using said task definitions module for automating identification of said teaching and learning processes;
wherein said design module designs new automations based on the recommendations from said analyze module;
wherein said design module is also coupled with a continuous assessment module;
wherein designs developed by said design module are continuously assessed by said continuous assessment module;
wherein based on the continuous assessment, a development module develops said new automations using a plurality of reusable components and technology stored in a corresponding technology component; and
further wherein said reusable components are selected from the group consisting of a lesson, a chapter, and a subject.

2. The teaching and learning automation system of claim 1, wherein said development module develops said new automations using a plurality of new components.

3. The teaching and learning automation system of claim 2 further comprising an integrate module configured to integrate said new automations into the existing said autonomous teaching and learning system for improving and personalizing the learning processes for a plurality of learners.

4. The teaching and learning automation system of claim 3 further comprising an orchestration build console coupled with said analyze module, said design module, said development module, and said integrate module for administering said teaching and learning processes.

5. The teaching and learning automation system of claim 4, wherein said database stores historical data, statistical data, and metadata of learners and courses received from an autonomous reporting engine.

6. The teaching and learning automation system of claim 5, wherein said database stores secure access information of the users for accessing said autonomous teaching and learning system.

7. The teaching and learning automation system of claim 6, wherein said autonomous reporting engine generates reports on said autonomous teaching and learning system using the data from said historical data, said statistical data, and said metadata of the learners and courses.

8. The teaching and learning autonomous system of claim 7, wherein said autonomous teaching and learning system having synchronous and asynchronous modes.

9. The teaching and learning autonomous system of claim 8, wherein said autonomous reporting engine configured to provide a virtual campus in a form of a learner community social network and includes a plurality of virtual learners.

10. The teaching and learning autonomous system of claim 9, wherein said plurality of virtual learners interact and collaborate with each other.

11. The teaching and learning autonomous system of claim 10 further comprising an operation administrator module configured to monitor an overall operation and administration of said autonomous teaching and learning system.

12. The teaching and learning autonomous system of claim 11, wherein said operation administrator module automatically operates a course delivery and automatically delivers and activates a course and learning processes.

13. The teaching and learning autonomous system of claim 12, wherein said course delivery team activates the courses using a course delivery console and said autonomous reporting engine for automatic delivery of said course and learning processes for virtual learners.

14. The teaching and learning autonomous system of claim 13, wherein said operation administrator module including said course delivery, a course monitoring, and a course reporting.

15. The teaching and learning autonomous system of claim 14, wherein said course monitoring monitors said teaching and learning processes and provides feedback to said autonomous reporting engine.

16. A teaching and learning automation system comprising:
an autonomous teaching and learning system having an automation opportunity module is configured to automate identification of teaching and learning processes, a task definitions module, a version control module for maintaining different versions of different said teaching and learning processes, a repository including a relational database, an analyze module, and a design module;
wherein said repository is maintained remotely and centrally;
wherein said analyze module analyzes the state of said teaching and learning processes, identifies areas for improvement, and generates recommendations for automation;
wherein said automation opportunity module using said task definitions module for automating identification of said teaching and learning processes;
wherein said design module designs new automations based on the recommendations from said analyze module;
wherein said design module is also coupled with a continuous assessment module;
wherein designs developed by said design module are continuously assessed by said continuous assessment module;
wherein based on the continuous assessment, a development module develops said new automations using a plurality of reusable components and technology stored in a corresponding technology component;
wherein said reusable components are selected from the group consisting of a lesson, a chapter, and a subject;
an operation administrator module configured to monitor an overall operation and administration of said autonomous teaching and learning system;
wherein said operation administrator module automatically operates a course delivery team and automatically delivers and activates a course or learning process;
wherein said database stores historical data, statistical data, and metadata of learners and courses received from an autonomous reporting engine; and
further wherein said course delivery team activates the courses using a course delivery console and said autonomous reporting engine for automatic delivery of the courses and learning processes for virtual learners.

17. The teaching and learning autonomous system of claim 16, wherein said operation administrator module including a course delivery, a course monitoring, and a course reporting.

18. The teaching and learning autonomous system of claim 17, wherein said course monitoring monitors said teaching and learning processes and provides feedback to said autonomous reporting engine.

19. The teaching and learning autonomous system of claim 18 further comprising an access management and security module adapted to provide access information for said course delivery, said course monitoring, and said course reporting.

20. A teaching and learning automation system comprising:
an autonomous teaching and learning system having an automation opportunity module is configured to automate identification of teaching and learning processes, a task definitions module, a version control module for maintaining different versions of different said teaching and learning processes, a repository including a relational database, an analyze module, and a design module;
wherein said repository is maintained remotely and centrally;
wherein said analyze module analyzes the state of said teaching and learning processes, identifies areas for improvement, and generates recommendations for automation;
wherein said automation opportunity module using said task definitions module for automating identification of said teaching and learning processes;
wherein said design module designs new automations based on the recommendations from said analyze module;
wherein said design module is also coupled with a continuous assessment module;
wherein designs developed by said design module are continuously assessed by said continuous assessment module;
wherein based on the continuous assessment, a development module develops said new automations using a plurality of reusable components and technology stored in a corresponding technology component;
wherein said reusable components are selected from the group consisting of a lesson, a chapter, and a subject;
an integrate module configured to integrate said new automations into the existing said autonomous teaching and learning system for improving and personalizing said teaching and learning processes for a plurality of learners;
an orchestration build console coupled with said analyze module, said design module, said development module, and said integrate module for administering said teaching and learning process; and
further wherein said database stores historical data, statistical data, and metadata of learners and courses received from an autonomous reporting engine.
